(19) United States
(12) Patent Application Publication
(10) Pub. No.: US 2002/0193985 A1
(43) Pub. Date: Dec. 19, 2002

(54) Method and system for displaying a user interface of an application program in a computer system, and a recording medium therefor

(76) Inventor: Hee-Chun Park, Suwon-city (KR)

Correspondence Address: Robert E. Bushnell, Suite 300, 1522 K Street, N.W., Washington, DC, 20005-1202, US

(21) Appl. No.: 09/987,950

(22) Filed: Nov. 16, 2001

(30) Foreign Application Priority Data
Jun. 13, 2001 (KR) 33188/2001

(51) Int. Cl. G06F 17/20

(52) U.S. Cl. 704/8

(57) ABSTRACT

System and method for displaying a user interface of an application in a computer having an operating program is provided. The system includes an operating system of a computer using a first basic language for a first user interface, an application program using a second language for a second user interface and running along with the operating system of the computer, and a language translation program being installed in the operating system of the computer and automatically translating the second user interface in the first basic language. The method includes the steps of executing the application program, determining the first and second languages for the first user interface of the operating system and for the second user interface of the application program, respectively, automatically comparing the second language with the first language, automatically translating the second language for the user interface of the application program into the first language for the user interface of the operating system when the first language is not identical to the second language, and automatically displaying the user interface of the application program in the first language.

### CLAIM OF PROPRITY

This application makes reference to, incorporates the same herein, and claims all benefits accruing under 35 U.S.C. §119 from an application for LANGUAGE DISPLAYING METHOD AND SYSTEM OF SOFTWARE FOR COMPUTER, RECORDING MEDIA OF COMPUTER PROGRAM THEREFOR earlier filed in the Korean Industrial Property Office on Jun. 13, 2001 and there duly assigned Serial No. 33188/2001 by that Office.

### BACKGROUND OF THE INVENTION

1. Field of the Invention

The present invention relates in general to method and system for displaying a user interface of an application program in an automatically selected language, and more particularly, to method and system for automatically translating the user interface of the application program into an automatically selected language, and for providing a storage medium storing a language translation program and being installed in the computer for automatically translating the language of the user interface of the application program in the automatically selected language.

2. Description of the Related Art

In a computer system are installed and executed various kinds of application or software programs. The computer system including a personal computer is provided with an operating system, such as Windows/NT. The operating system includes a group of basic programs allowing the computer to perform basic functions while the application program allows the computer to have special functions of driving hardware devices, such as a printer connected to the computer. Typically, the application program requires a user interface in order to display on a monitor of the computer presentations or screen displays of the application program, such as menu bars, dialog boxes, message displays, instruction texts, help texts, etc., when the application program is executed and installed in the computer.

A process of developing an application program is described in FIG. 4. The process includes the steps of analyzing functions of an application program to be developed, making a development plan thereof, drafting algorithms for the application program, converting the algorithms into a plurality of programs, integrating the programs into the application program, and finally testing the application program. In the step of converting the algorithms into the programs, each program is run and tested. A plurality of files for each user interface (UI) are created during the converting step.

When the application program using a foreign language for the screen displays or the presentation of the UI is executed in the computer, the screeen displays or the presentataions of the UI of the application program are displayed in abnormal letters in the monitor of the computer if the user graphical interface of the operating system cannot support the language of the UI of the application program, or if the language for the UI of the operating system is neither identical to nor compatible with a foreign language of the UI of the application program. Thus, in order to use the application program in any operating system of the computer using any basic language, the developing process of the applications program further requires that screen displays and the presentations for the UI of the application program are individually programmed in a number of different languages including the foreign and basic language, and that a lot of UIs programmed in the various foreign and basic languages are tested for the screen displays and the presentations during the programming precess.

However, when the UIs are individually programmed in a number of various foreign and basic languages, the programming process becomes complicated. Moreover, the developing process of the application program is disadvantageous because the manufacturing cost of the application program would not be reduced.

### SUMMARY OF THE INVENTION

It is an object of the present invention to provide improved method and system able to display a user interface of an application program on a monitor of a computer in an automatically selected language.

It is another object to provide improved method and system for reduce manufacturing cost and time for making an application program exeuted in a computer.

It is still an object to provide improved method and system able to automatically translate presentations and screen display of a user interface of an applicatoin program in an automatically selected language.

It is yet another object to provide improved method and system able to translate presentations and screen display of a user interface of an application program into the language for an operating system of a computer.

It is still yet another object to provide improved method and system able to provide a storage medium storing a program causing a computer to perform translating the user interface of an application program in a basic language used in an operating system of the computer when the application program is executed in the operating system of the computer having the basic language different from the application program.

It is also an object to provide an improved operating system of a computer able to remove a plurality of user interfaces using different languages from an application program except a desired user interface using a desired language.

It is further an object to provide method and system enabling an application program to have only a single language for a user interface which is able to be translated in the same language as the operating system of a computer by a language tanslation program.

These and other objects may be achieved by providing method and system separately providing an operating system of a computer using a first or basic language for a first user interface, an application program using a second or foreign language for a second user interface and executed along with the operating system in the computer, and a language translation program being installed in the operating system of the computer and automatically translating the second user interface into the first language.

The method includes the steps of executing the applications program, determining the kind of each language for the user interfces of the application program and the operating system, comparing the kind of the second language for the user interface of the application program with the kind of the first language for the user interface of the operating system, automatically translating the second language of the application program into the first language of the operating system when the two languages are not identical to each other, and displaying the user interface of the application program in the first language of the operating system.

The translating step inlcudes the steps of translating the second language of the application program into a common language, and translating the common language into the same language as the operating system.

The system for displaying the first and second interfaces of the operating system of the computer and the application program includes a language translation part having at least one encoding program, a language determining part recognizing the first and second languages of the operating system and the application program, and a control part comparing the kind of the first language of the operating system with the kind of the second language of the application program and controlling the language translation part to encode the second language of the second user interface into the first language when the kind of the second language of the application program is not identical to the first language of the operating system.

The system further inlcudes a common language translation part translating the second language of the application program into the common language, and the control part controls the language translation part to translate the common language translated by the common language translation part into the first language of the operating system.

A first computer readable storage medium for storing programming instructions causing the computer to perform a language translation includes the language translation part, the language determining part, and the control part and is read by the computer, and then the programming instructions for the language translating is installed in the computer. A second medium for storing an application program having the second user interface in the second language is read by the computer, and the application program is read by the computer, and then the application program is installed in the computer to perform a displaying function of the second user interfce of the application in the computer. The first medium and the second medium are separately provided and individually installed in the computer. The second medium does not include the second user interface in more than two different language while programming instructoins stored in the first medium enables the computer to translate the second user interface into one of the first and second languages.

### BRIEF DESCRIPTION OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1 is a block diagram illustrating an operating system constructed according to the principle of the present invention;

FIG. 2a is a block diagram showing a direct translation of a language translation part of FIG. 1;

FIG. 2b is a block diagram showing an indirect translation of the language translation part of FIG. 1;

FIG. 3 is a flow chart showing a method of automatically translating and displaying a display screen in an automatically selected language in a computer constructed according to the principle of the present invention; and

FIG. 4 is a flow chart of a conventional method for developing application and basic program.

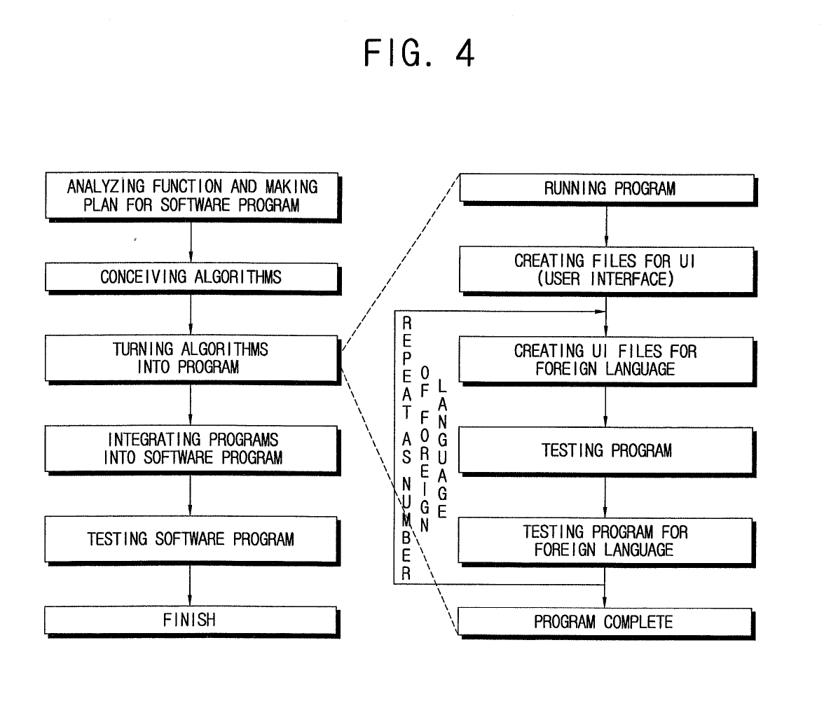

### DETAILED DESCRIPTION OF THE INVENTION

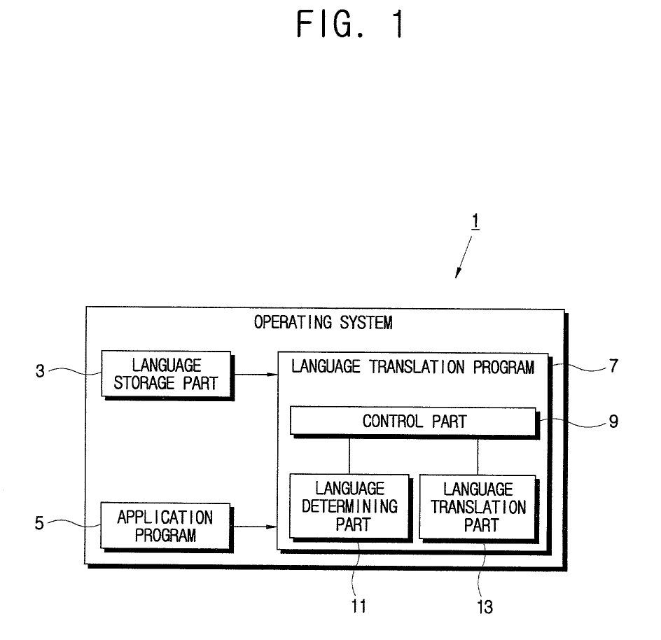

FIG. 1 is a block diagram showing an operating system (OS) 1 of a computer for displaying a user interface in a language. Operating system 1 of the computer, such as a personal computer, includes a group of basic programs controlling and performing basic operations of the computer. An application or software program 5 is installed in the computer and operated in dependence with operating system 1.

A first or basic language is used for displaying a first user graphical interface of operating system 1 while a second or foreign language is used for displaying a second user interface of application program 5, such as presentations or screen displays of application program 5, on a monitor of the computer. Whenever application program 5 is executed in the computer, the second user interface of the application program is supposed to be displayed in the second language on the monitor regardless of the first language of operating system 1.

A user interface displaying function of operating system 1 includes a language translation 5 program 7 installed into the operating system 1. The language translation program 1 may be individually provided in a first storage medium separate from said operating system 1 and installed in operating system 1 of the computer. Language translation program 7 translates either from the second language into the first language or from the first language into the second language.

Language translation program 7 connected to application program 5 includes a language determining part 11 receiving and recognizing both the kind of the first language of operating system 1 and the kind of the second language of application program 5, a language translation part 13 translating the second language used for displaying the second user interface of application program 5 by means of a plurality of encoding programs for translation, such as English to Korean, Japanese to Korean, French to Korean, etc., a control part 9 comparing the kind of the first language with the kind of the second language to automatically make a determination whether the first and second languages used in operating system 1 and application program 5 are identical to each other, and controlling a language translation part 13 to automatically translate the second language used for displaying the second user interface of application program 5 into the first language in response to the comparison and the determination of language determinating part 11, thereby displaying presentations or screen displays of the second user interfce of application program 5 in the first language.

Language translation program 7 is stored in a hard disk drive (not shown) of the computer. When the computer is booted, language translation program 7 is read from the hard disk drive and stored in operating system 1 to be simultaneously operated together with operating system 1 when application program 5 operates.

Language determining part 11 recognizes the each kind of the first language of operating system 1 and the second language of application program 5 through an application program interface (API). The API includes a means for calling a function for exchanging information of operating system 1 and application program 5 when operating system 1 communicates with application program 5. Control part 9 receives the information about the kind of the first language of operating system 1 from a language storage part 3 of operating system 1 by calling the function of “GetSystemDefaultLangID” through the API, and further receives the information about the kind of the second language from application program 5 when application program 5 is executed in the computer. Language determining part 11 recognizes the kind of the second language of the second user interface of application program 5 through program files related to the second user interface of application program 5.

Language translation part 13 includes a plurality of encoding programs for translation, such as English-Korean, Japanese-Korean, French-Korean, etc. When application program 5 is executed, the second user interface of application program 5 is supposed to be newly displayed on the monitor of the computer. Language translation part 13 reads presentations or screen displays of the second user interface, such as menu bars, letters, texts, etc., from program files related to the second user interface of application program 5 and translates the presentations or the screen displays into the first language.

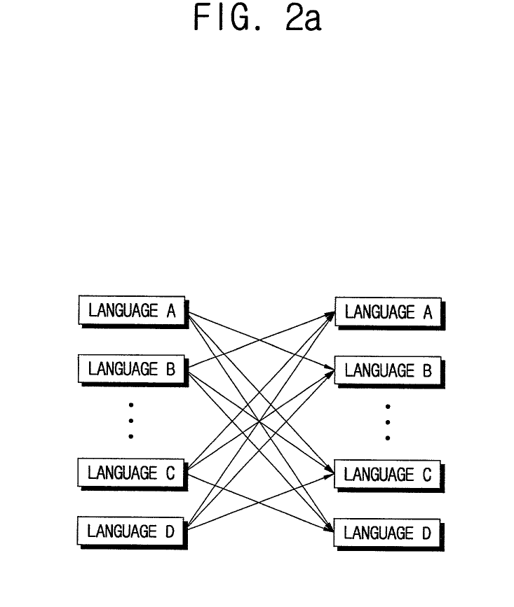

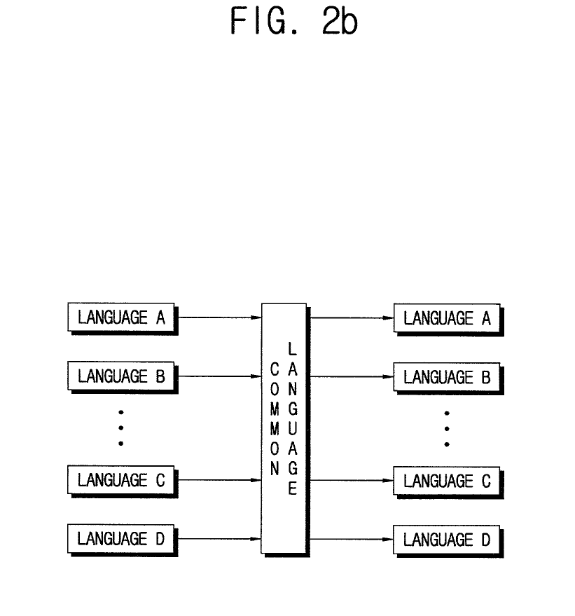

Language translation part 13 has two different translation methods: direct and indirect translation methods. FIGS. 2a and 2b are block diagrams showing the direct and indirect translation methods performed in language translation part 13 of FIG. 1. Language determining port 11 recognizes and determines the first language of operating system 1 and the second language application program 5 as language A and language B, respectively. When language translation part 13 performs the direct translation method, language translation part 13 directly encodes language B, the second language for displaying the second user interface of application program 5, into language A, the first language for displaying the first user interface operating system 1.

On the other hand, if the indirect translation method is used, language translation part 13 encodes language B into a common language (e.g. English) through a common language translation part (not shown) and then encodes the common language into language A, the first language for the indirect translation method. Therefore, language translation program 7 either translates from the second language into a common language and then from the common language to the first language of translates from the first language into the common language and then from the common language into the second language in accordance with encoding procedures of language translation part 13.

Here, the direct translation method can be performed relatively and comparatively faster than the indirect translation method. However, the direct translation method needs a number of n(n-1) encoding programs while the indirect translation method requires a number of 2n encoding programs comparatively less than the direct translation method. Nevertheless, the direct translation method is more accurate than the indirect translation method.

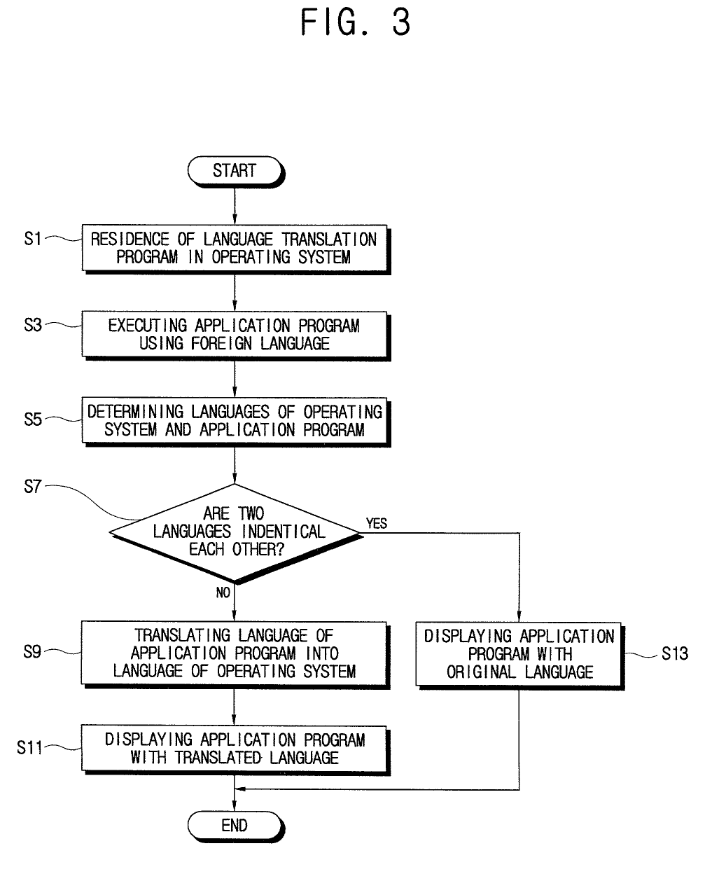

FIG. 3 is a flow chart of a user interface displaying method of the computer. Language translation program 7 is installed in the computer and stored within operating system 1 to be operated together with operating system 1 in step S1. If application program 5 using the second language for the second user interface is executed in step S3, language determining part 11 recognizes and determines the first language of operating system 1 and the second language of application program 5 in step S5. Control part 9 compares the first language with the second language in step S7 and controls language translation part 13 to encode the second language for the second user interface of application program 5 into the first language when the first and second languages are not identical to each other in step S9, thereby displaying the second user interface of application program 5 in the first language in step S11. Thus, the user may read the presentations and screen dispplays of the second user interface displayed in the first language.

With this configuration, the second language for the second user interface of application program 5 operated by operating system 1 can be translated into the first language of operating system 1, and then the presentations or screen displays of the second user interface are displayed in the same first language as operating system 1, thereby allowing a user to easily read in the first language of the computer the second user interface of application program 5 which is supposed to be displayed in the second language. If the second language is identical to the first language, the second user interface of application program 5 is dispalyed in the first language in step S13.

Moreover, because an application program developer does not have to separately make the second user interface of the application program into a number of various and different foreign languages, the time and the cost for developing the application program can be significantly reduced.

Language translation program 7 constructed according to the principle of the present invention is stored in various types of the first recoding medium, such as a floppy diskette, a compact disk, an optical disk, etc. The first recording medium may be separately manufactured from application program 5 and installed in the computer prior to the installation of the application program in the computer. When the first recording medium is operated in the computer, language translation program 7 stored in the recording medium is read by the computer and stored the hard disk drive of the computer. Whenever the computer is booted, language translation program 7 is stored within operating system 1 to be simultaneous operated together with operating system 1. Thus, application program 5 is operated in the computer, application program 5 and language translation program 7 are operated simultaneously.

The first storage medium stores programming instructions that, when read by the computer having operating system 1 and application program 5, causes the computer to perform the user interface displaying and translating method, the storage medium including a language determining unit that when executed in by the computer, causes the computer to recognize and determine the kind of the first language used in the first user interface of operating system 1 and the second language used in the second user interface of application program 5, a language translation unit that when executed by the computer, causes the computer to translate the second language to the first language, and a control unit that when executed by the computer, causes the computer to compare the first language with the second language and to control the language translation unit to translate the second language into the first language when the kind of the first language is not identical to the kind of the second language.

The first storage medium stores programming instructions that, when read by a processor in the computer having operating system 1 and application program 5, causes the processor of the computer to perform recognizing and determining the kind of the first language used in the first user interface of operating system 1 and the second language used in the second user interface of application program 5, making a determination of whether the kind of the first language is identical to the kind of the second language, and translating the second language into the first language in response to the determination that the kind of the first language is not identical to the kind of the second language.

Moreover, a second storage medium for storing application program 5 having the second user interface only in the second language is separately provided from the first storage medium. The second storage medium is read by the computer, and then the application program 5 is installed in the computer to perform a displaying function of the second user interfce of the application in the computer. The first storage medium and the second storage medium may be separately provided and separately installed in the computer. The second storage medium does not include the second user interface in more than two different language because the first storage medium enables the second user interface to be translated into one of the first and second languages. Therefore, even if application program 5 does not have the second user interface in the same language as the operating system of the computer, any application program constructed according to the principle of the present invention can be installed in any computer having the language translation program.

Further, the present invention may be applied to a small mobile computer, such as a personal digital assistants (PDA), a palm personal computer, etc., which includes an operating system.

As described above, the present invention provides the user interface translating and displaying method and system which can display the second user interface of an application program in any basic language used in the first user interface of the operating system of the computer. Further, because a software program developer does not have to separately create the user interface in a plurality of different foreign languages, the time and the cost of developing the application program can be reduced.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A user interface displaying method in a computer using a first language for a first user interface of an operating system, comprising: the steps of:
providing a first storage medium storing an application program using only a second language for a second user interface of said application program;
providing a second storage medium storing a language translation program translating either from said second language into said first language or from said first language into said second language;
installing said application program and said language translation program into said computer when said first and second media are executed in the computer;
determining the kind of said first language of said operating system and the kind of said second language of said application program;
making a determination of whether said second language is the same kind as said first language;
translating the second language for said second user interface of said application program into said first language in response to said determination; and
displaying said second user interface of said application program in said first language of said operating system.

2. The method of claim 1, further comprising of the step of translating said second language of said application into a third language and translating the translated third language into said first language of said operating system.

3. The method of claim 1, wherein said application program does not use any language other than said second language for displaying said second user interface of said application program.

4. The method of claim 1, wherein said operating system uses only said first language.

5. The method of claim 1, further comprising the step of providing said first storage medium and said second storage medium separately.

6. The method of claim 1, further comprising the step of providing said operating system containing said language translating program translating either from said second language into said first language or from said first language into said second language.

7. The method of claim 1, further comprising the step of providing said operating system containing said language translation program either translating from said second language into a third language than than from said third language to said first language or translating from said first language into said third language and from said third language into said second language.

8. A method in a computer having an operating system using a first language for displaying a first user interface of said operating system, comprising the steps of:
providing an application program using a second language for a second user interface of said application program; wherein said application program does not use other language than said second language for said application program;
providing a language translation program translating either from said second language into said first language or from said first language into said second language; and
separately installing said application program and said language translation program in said computer.

9. The method of claim 8, further comprising the step of providing said application program not having any other interface using a third language except said second user interface using said second language.

10. The method of claim 8, further comprising the step of providing said language translation program either translating from said second language into a third language and than from said third language to said first language or translating from said first language into said third language and from said third language into said second language.

11. A system in a computer having an operating system using a first language for displaying a first user interface of said operating system, comprising:
an application program unit independently installed in said computer and having a second user interface using a second language; and
a language translation program unit separately provided from said application program unit and independently installed in said computer, said language translation program unit translating either from said second language into said first language or from said first language into said second language when said language translation program is simultaneously operated together with said application program.

12. The system of claim 11, with said application program unit not using other language except said second language for said second user interface of said application program, said application program not having other interface than said second user interface using said second language.

13. The system of claim 11, with said language translation program unit either translating from said second language into a third language and than from said third language to said first language or translating from said first language into said third language and from said third language into said second language.

14. The system of claim 11, with said language translation program unit comprising:
a language translation part having at least one encoding program both encoding from said second language to said first language and encoding from said first language to said second language;
a language determining part recognizing and determining each kind of said first and second languages of said operating system and said software program; and
a control part comparing the kind of said first language of said operating system with the kind of said second language of said application program and controlling said language translation part to encode said second language of said application program into said first language when the kind of said first language is not identical to the kind of said second language.

15. The system of claim 14, further comprising:
a common language translation part translating said second language of said application program into a common language; and
said control part controlling said language translation part to translate said common language translated by said common language translation part into said first language.

16. A computer readable medium storing programming instructions that, when read by a machine having an operating system and having an application program installed, causes the machine to perform a language translation, comprising:
a language determining unit that when executed in by the machine, causes the machine to recognize and determine the kind of a first language used in a first user interface of said operating system and a second language used in a second user interface of said application program;
a language translation unit that when executed by the machine, causes the machine to translate said second language to said first language; and
a control unit that when executed by the machine, causes the machine to compare said first language with said second language and to control said language translation unit to translate said second language into said first language when the kind of said first language is not identical to the kind of said second language.

17. The medium of claim 16, with said language translation unit that when executed by the machine, causes the machine to translate said second language into a third language and then translate said third language into said first language.

18. A storage medium storing programming instructions that, when read by a processor in a computer having an operating system and receiving an application program, causes the processor of the computer to perform:
recognizing and determining the kind of a first language used in a first user interface of said operating system and a second language used in a second user interface of said application program;
making a determination of whether the kind of said first language is identical to the kind of said second language; and
translating said second language into said first language in response to said determination that the kind of said first language is not identical to the kind of said second language.

19. The storage medium of claim 18, further comprising programming instructions that, when read by the processor in the computer, causes the processor of the computer to perform translating from said second language into a third language and then from said third language to said first language.
